(19) United States
(12) Patent Application Publication
(10) Pub. No.: US 2012/0212438 A1
(43) Pub. Date: Aug. 23, 2012

(54) METHODS AND APPARATUSES FOR FACILITATING INTERACTION WITH TOUCH SCREEN APPARATUSES

(75) Inventor: Matti Vaisanen, Espoo (FI)

(73) Assignee: NOKIA CORPORATION, Espoo (FI)

(21) Appl. No.: 13/459,852

(22) Filed: Apr. 30, 2012

Related U.S. Application Data
(63) Continuation of application No. 12/615,520, filed on Nov. 10, 2009.
Application No. 12/615,520 is a continuation-in-part of application No. 12/258,930, filed on Oct. 27, 2008, now abandoned.

(51) Int. Cl. G06F 3/041

(52) U.S. Cl. 345/173

(57) ABSTRACT

Methods and apparatuses are provided for facilitating interaction with touch screen apparatuses. A method may include detecting a touch interaction with a touch screen display. The method may further include identifying the touch interaction as comprising a trigger touch interaction. The trigger touch interaction may include sliding an input object along a path from a point of origin outside of an active region of the touch screen display to a point within the active region. The method may further include determining, based at least in part upon the trigger touch interaction, a function associated with the trigger touch interaction. The method may additionally include executing the determined function. Corresponding apparatuses are also provided.

### CROSS-REFERENCE TO RELATED APPLICATIONS

This application is a continuation of U.S. patent application Ser. No. 12/615,520, filed Nov. 10, 2009, which is a continuation-in-part of U.S. patent application Ser. No. 12/258,930, filed on Oct. 27, 2008, the contents of both of which are incorporated herein by reference.

### TECHNOLOGICAL FIELD

Embodiments of the present invention relate generally to user interface technology and, more particularly, relate to methods and apparatus for facilitating interaction with touch screen apparatuses.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used for execution of a wide range of applications.

Traditionally, WIMP (windows icons menus pointer) input devices have been used to provide a way for users to interact with computing devices. WIMP input devices may offer a mouse pointer, a left and right mouse button, a scroll wheel, keyboard scroll keys, and keyboard modifiers for mouse-clicks (e.g., control-left-mouse). However, advancing computing technology and the shrinking form factor of mobile computing devices has given rise to new devices for allowing user interaction with computing devices. One such device that is gaining popularity is a touch screen display. Touch screen displays allow users to interact with and send commands to a computing device by touching an input object to the surface of the touch screen display.

Such touch screen displays facilitate small form factor mobile devices on which there may not be sufficient room to include a display as well as one or more traditional buttons, keys, joysticks, and/or the like for allowing the user to send commands to and interact with the computing device. Moreover, inputting commands to the computing device by tangibly touching a portion of a graphical user interface displayed on a touch screen display may be quite intuitive to some users. Nevertheless, the lack of other input buttons or keys in addition to the touch screen display on many small form factor mobile devices inhibits the ability of a touch screen display to facilitate replacement of the full range of functionality and input options provided by traditional input devices, such as WIMP input devices.

### BRIEF SUMMARY OF SOME EXAMPLES OF THE INVENTION

Methods, apparatuses, and computer program products are therefore provided for facilitating interaction with touch screen apparatuses. In this regard, methods, apparatuses, and computer program products are provided that may provide several advantages to computing devices and computing device users. Embodiments of the invention provide touch screen apparatuses configured to detect a trigger touch interaction associated with a function and to execute the determined function. In some embodiments, a designated trigger touch interaction is associated with a function to change a mode of interaction with a graphical user interface displayed by a touch screen display. Such a mode of interaction controls the effect of touch interactions with the touch screen display. According to some such embodiments, a user may provide the designated trigger touch interaction as a command to the touch screen apparatus and, in response, the touch screen apparatus is configured to switch from a default mode of interaction to a hover mode of interaction, which according to some embodiments enables a user to interact with displayed content objects via touch interaction to command hover events (“mouse-over events”). Touch screen devices according to some embodiments of the invention are configured, in response to a second designated trigger touch interaction, to switch from hover mode to the default mode of interaction, which according to some embodiments enables a user to command panning interactions (e.g., moving a document inside a browser or application window), direct manipulation/interaction with an application (e.g., selecting text, activating an application option, and/or the like), such as may be performed using a left-click with a traditional WIMP device (“mouse-click events”).

Accordingly, embodiments of the invention provide enhanced support for Internet or hypermedia applications (e.g., web browsers), office applications (e.g., word processing applications, spreadsheet applications, and/or the like), and/or the like via a touch screen display by allowing a user to switch modes of interaction without degrading the capability to support more frequently needed functionalities, such as moving a portion of a document displayed by the touch screen display via panning, which may be performed in a default mode of interaction. Embodiments of the invention further provide for one hand usage of touch screen apparatuses without requiring a user to use a second hand to enter key strokes or other input to change a mode of interaction controlling the effect of touch interactions with the touch screen display. Embodiments of the invention additionally do not require special hardware keys/buttons or graphical user interface keys/buttons for switching between modes of interaction and provide the ability for a user to alternate between modes of interaction at any time with a designated trigger touch interaction.

In a first example embodiment, a method is provided, which comprises detecting a touch interaction with a touch screen display. The method of this embodiment also comprises identifying the touch interaction as comprising a trigger touch interaction. The trigger touch interaction of this embodiment comprises sliding an input object along a path from a point of origin outside of an active region of the touch screen display to a point within the active region. The method further comprises determining, based at least in part upon the trigger touch interaction, a function associated with the trigger touch interaction. The method additionally comprises executing the determined function.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least detect a touch interaction with a touch screen display. The at least one memory and stored computer program code are configured to, with the at least one processor, also cause the apparatus of this embodiment to identify the touch interaction as comprising a trigger touch interaction. The trigger touch interaction of this embodiment comprises sliding an input object along a path from a point of origin outside of an active region of the touch screen display to a point within the active region. The at least one memory and stored computer program code are configured to, with the at least one processor, further cause the apparatus of this embodiment to determine, based at least in part upon the trigger touch interaction, a function associated with the trigger touch interaction. The at least one memory and stored computer program code are configured to, with the at least one processor, additionally cause the apparatus of this embodiment to execute the determined function.

In another example embodiment, a computer program product is provided. The computer program product includes at least one computer-readable storage medium having computer-readable program instructions stored therein. The computer-readable program instructions may include a plurality of program instructions. The program instructions of this embodiment comprise program instructions configured for detecting a touch interaction with a touch screen display. The program instructions of this embodiment also comprise program instructions configured for identifying the touch interaction as comprising a trigger touch interaction. The trigger touch interaction of this embodiment comprises sliding an input object along a path from a point of origin outside of an active region of the touch screen display to a point within the active region. The program instructions of this embodiment further comprise program instructions configured for determining, based at least in part upon the trigger touch interaction, a function associated with the trigger touch interaction. The program instructions of this embodiment additionally comprise program instructions configured for executing the determined function.

In another example embodiment, an apparatus is provided that comprises means for detecting a touch interaction with a touch screen display. The apparatus of this embodiment also comprises means for identifying the touch interaction as comprising a trigger touch interaction. The trigger touch interaction of this embodiment comprises sliding an input object along a path from a point of origin outside of an active region of the touch screen display to a point within the active region. The apparatus of this embodiment further comprises means for determining, based at least in part upon the trigger touch interaction, a function associated with the trigger touch interaction. The apparatus of this embodiment additionally comprises means for executing the determined function.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a touch screen apparatus according to an example embodiment of the present invention;

FIG. 2 is a schematic block diagram of a mobile terminal according to an example embodiment of the present invention;

FIG. 3 illustrates a system for facilitating interaction with touch screen apparatuses according to an example embodiment of the present invention;

FIG. 4 illustrates a side profile and front profile of an example embodiment of a touch screen apparatus;

FIG. 5 illustrates a touch interaction having a point of origin within an active region of a touch screen display according to an example embodiment of the invention;

FIG. 6 illustrates a touch interaction having a point of origin outside of an active region of a touch screen display according to an example embodiment of the invention;

FIG. 7 illustrates a series of touch interactions with content displayed by a touch screen display according to an example embodiment of the invention;

FIG. 8 illustrates a flowchart according to an example method for facilitating interaction with touch screen apparatuses according to an example embodiment of the invention; and

FIG. 9 illustrates a flowchart according to an example method for facilitating interaction with touch screen apparatuses according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As many touch screen displays rely almost entirely on touch on the screen by one or more input objects (e.g., a finger, stylus, pen, pencil, and/or the like), touch screen displays may not provide the full range of input options provided by a traditional WIMP input device even where the underlying application or content being viewed, edited, or otherwise used on the touch screen device requires similar control information to the same or substantially similar application or content on a computing system having a traditional WIMP input device.

This problem may become especially apparent when a user is attempting to interact with a content object, which may for example, comprise a dynamic object having a defined hover event (e.g., a “mouse-over” and/or “mouse-out” event). The content object may be configured to change in appearance or perform such function in response to a cursor being positioned over the content object (e.g., hovering over the object) or being moved away from the object. These hover events may comprise, for example, displaying information about the content object, displaying a menu or submenu when a cursor is placed over a content item, and/or the like. Such hover events may, for example, be implemented with JavaScript, Cascading Style Sheets (CSS), Flash, and/or the like.

In addition to hover events associated with content objects, a user may further need to interact with content objects and/or a document or application containing a content object to select/activate a function, option, content object (e.g., selecting a menu option), and/or the like. A user may further need to perform panning functionality to change the displayed portion of a document. Panning may be used frequently on touch screen devices, which may have a smaller display area capable of displaying a smaller portion of a document than the larger monitors used for desktop computers.

With a WIMP input device, hover events may be triggered by positioning a cursor controlled by the WIMP input device over the content object. Additionally, a button of the WIMP devices (e.g., a left click) may be used to perform selection/activation and panning functionality. Accordingly, the WIMP input device may provide sufficient input options to disambiguate user interaction with a content object and/or with a document or application containing the content object. With a touch screen display, however, simply placing an input object over a content object may be ambiguous, as it may be unclear whether the user is tapping (e.g., to select or activate) the content object or is hovering (e.g., to trigger a hover event) over the content object. Accordingly, embodiments of the invention provide methods, apparatuses, and computer program products for facilitating interaction with touch screen apparatuses.

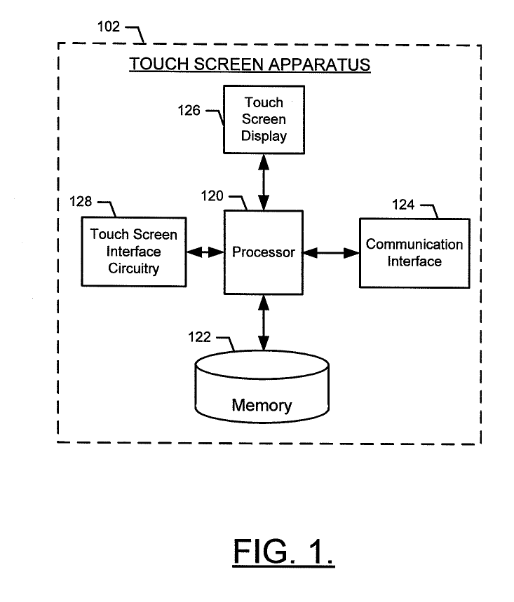

FIG. 1 illustrates a block diagram of a touch screen apparatus 102 according to an example embodiment of the present invention. It will be appreciated that the touch screen apparatus 102 is provided as an example of one embodiment for the invention and should not be construed to narrow the scope or spirit of the invention in any way. In this regard, the scope of the invention encompasses many potential embodiments in addition to those illustrated and described herein. As such, while FIG. 1 illustrates one example of a configuration of a touch screen apparatus, numerous other configurations may also be used to implement embodiments of the present invention.

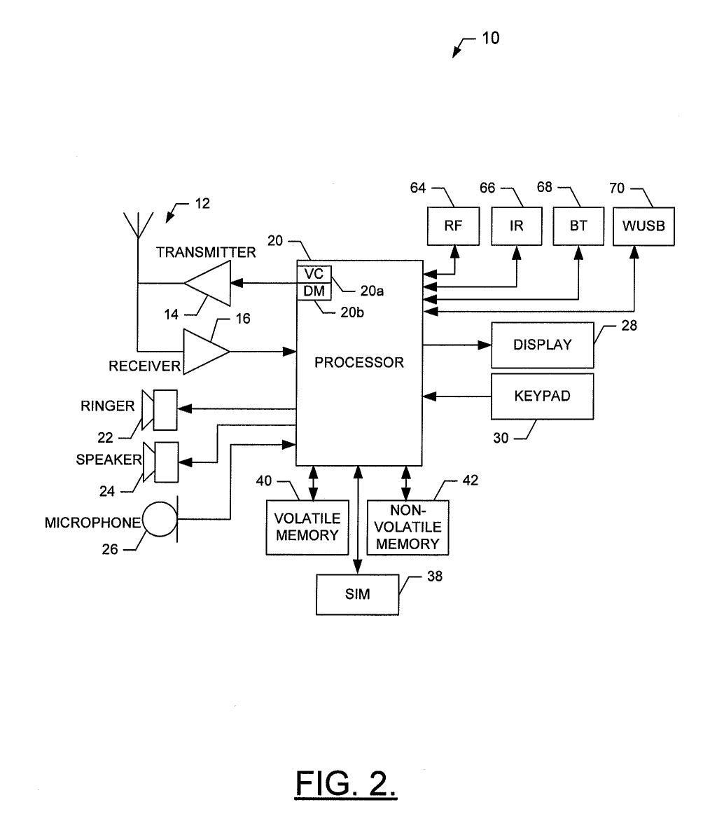

The touch screen apparatus 102 may be embodied as any computing device comprising a touch screen display. Such a computing device may comprise, for example, a mobile terminal, mobile computer, mobile phone, mobile communication device, personal digital assistant (PDA), game device, digital camera/camcorder, audio/video player, television device, radio receiver, digital video recorder, positioning device (e.g., a global positioning system device), an electronic book reading device, a laptop computer having a touch screen display, a desktop computer having a touch screen display, a touch screen input device configured to function as an input device for another computing device, and/or the like. In an example embodiment, the touch screen apparatus 102 is embodied as a mobile terminal, such as that illustrated in FIG. 2.

In this regard, FIG. 2 illustrates a block diagram of a mobile terminal 10 representative of one embodiment of a touch screen apparatus 102 in accordance with embodiments of the present invention. It should be understood, however, that the mobile terminal 10 illustrated and hereinafter described is merely illustrative of one type of touch screen apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a processor 20 configured to provide signals to and to receive signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or elements of the user interface, such as, for example, the speaker 24, the ringer 22, the microphone 26, the display 28, and/or the like. In an example embodiment, the display 28 comprises a touch screen display. The touch screen display may comprise any known touch screen display that may be configured to enable touch recognition by any suitable technique, such as resistive, capacitive, infrared, strain gauge, surface wave, optical imaging, dispersive signal technology, acoustic pulse recognition, etc. techniques.

The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning now to FIG. 1, in an example embodiment the touch screen apparatus 102 includes various means, such as a processor 120, memory 122, communication interface 124, touch screen display 126, and touch screen interface circuitry 128 for performing the various functions herein described. These means of touch screen apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. In embodiments wherein the touch screen apparatus 102 is embodied as a mobile terminal 10, the processor 120 may be embodied as or comprise the controller 20. In an example embodiment, the processor 120 is configured to execute instructions stored in the memory 122 or otherwise accessible to the processor 120. These instructions, when executed by the processor 120, may cause the touch screen apparatus 102 to perform one or more of the functionalities of the touch screen apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. Although illustrated in FIG. 1 as a single memory, the memory 122 may comprise a plurality of memories. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the touch screen apparatus 102 is embodied as a mobile terminal 10, the memory 122 may comprise the volatile memory 40 and/or the non-volatile memory 42. The memory 122 may be configured to store information, data, applications, instructions, or the like for enabling the touch screen apparatus 102 to carry out various functions in accordance with example embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the touch screen interface circuitry 128 during the course of performing its functionalities.

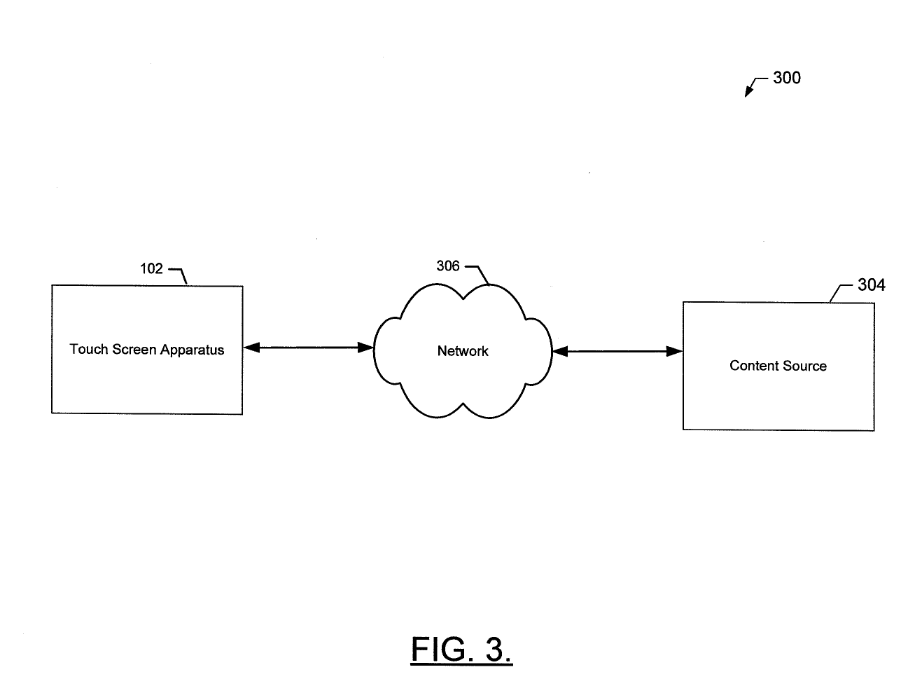

The communication interface 124 may be embodied as any device or means embodied in circuitry, hardware, a computer program product comprising computer readable program instructions stored on a computer readable medium (e.g., the memory 122) and executed by a processing device (e.g., the processor 120), or a combination thereof that is configured to receive and/or transmit data from/to another device, such as, for example, a content source (e.g., the content source 304 illustrated in FIG. 3). In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with another computing device. The communication interface 124 may be configured to receive and/or transmit data with another computing device over a dedicated link, over a network (e.g., cellular network, wireless network, wireline network, the internet, and/or some combination thereof), and/or the like. The communication interface 124 may be configured to receive and/or transmit data using any protocol that may be used for communications between computing devices. The communication interface 124 may additionally be in communication with the memory 122, touch screen display 126, and/or touch screen interface circuitry 128, such as via a bus.

The touch screen display 128 may comprise any known touch screen display that may be configured to enable touch recognition by any suitable technique, such as, for example, resistive, capacitive, infrared, strain gauge, surface wave, optical imaging, dispersive signal technology, acoustic pulse recognition, and/or other suitable touch recognition techniques. Accordingly, the touch screen display 126 may be in communication with the processor 120 and/or touch screen interface circuitry 128 to receive an indication of a user input in the form of a touch interaction (e.g., a contact between the touch screen display and an input object). The touch screen display 126 may be further in communication with the processor 120 and/or touch screen interface circuitry 126 to provide a graphical output to the user. This graphical output may comprise, for example, a graphical user interface, application data, document data, and/or the like to facilitate a user's use of and interaction with applications executed or otherwise implemented on the touch screen apparatus 102. In embodiments wherein the touch screen apparatus 102 is embodied as a mobile terminal 10, the touch screen display 126 may comprise the display 28. The touch screen display 126 may be in communication with the processor 120, memory 122, communication interface 124, and/or touch screen interface circuitry 128, such as via a bus.

Although not illustrated in FIG. 1, the touch screen apparatus 102 may additionally comprise one or more user interface elements in addition to the touch screen display 126. These additional user interface elements may be in communication with the processor 120 to receive an indication of a user input and/or to provide an audible, visual, mechanical, or other output to a user. As such, the additional user interface elements may include, for example, one or more of a keyboard, a mouse, a joystick, an additional display, a microphone, a speaker, and/or other input/output mechanisms. Any additional user interface elements embodied on the touch screen apparatus 102 may be in communication with the memory 122, communication interface 124, and/or touch screen interface circuitry 128, such as via a bus.

The touch screen interface circuitry 128 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the touch screen interface circuitry 128 is embodied separately from the processor 120, the touch screen interface circuitry 128 may be in communication with the processor 120. The touch screen interface circuitry 128 may further be in communication with one or more of the memory 122, communication interface 124, or touch screen display 126, such as via a bus.

FIG. 3 illustrates a system 300 for facilitating interaction with touch screen apparatuses according to an example embodiment of the present invention. In this regard, FIG. 3 illustrates the touch screen apparatus 102 in communication with a content source 304 over a network 306. The network 306 may comprise a wireless network (e.g., a cellular network, wireless local area network, wireless personal area network, wireless metropolitan area network, and/or the like), a wireline network, or some combination thereof, and in some embodiments comprises at least a portion of the interne. The content source 304 may comprise any device configured to interface with the touch screen apparatus 102 over the network 306 to send data to and/or receive data from the touch screen apparatus 102 over the network 306. In this regard, the content source 304 may comprise a server, web server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like. In this regard, the content source 304 may be configured to send data or content, such as, for example, application data, web page content, online gaming data, multiplayer gaming data, and/or the like to the touch screen apparatus 102 for display on the touch screen display 126.

In an example embodiment, the touch screen interface circuitry 128 is configured to communicate with the touch screen display 126 to receive indications of touch interactions (also referred to as “gestures”) with the touch screen display 128. The touch screen interface circuitry 128 is configured in some embodiments to detect and/or identify one or more predefined trigger touch interactions based on the received indication of the touch interaction. In this regard, the touch screen interface circuitry 128 may be configured to distinguish between a trigger touch interaction having a predefined association with a function and other touch interactions that may be used for performing various application operations, or the like. The touch screen interface circuitry 128 is further configured in some embodiments to determine, based at least in part upon the detected trigger touch interaction, a function having a predefined association with the trigger touch interaction. This predefined association may be stored in the memory 122, for example, and may be defined by an application programmer, operating system programmer, a user selected option, some combination thereof, or the like. The touch screen interface circuitry 128 is additionally configured in some embodiments to execute the determined function. It will be appreciated that in embodiments wherein the touch screen interface circuitry 128 is configured to execute the determined function, the touch screen interface circuitry 128 may be configured to execute the determined function by directly executing the determined function and/or by indirectly executing the determined function by directing the processor 120 to execute the determined function.

In an exemplary embodiment, a trigger touch interaction comprises sliding an input object along a path from a point of origin outside of an active region of the touch screen display 126 to a point within the active region. This trigger touch interaction may be referred to as a “slide-in gesture.” It will be appreciated, that in some embodiments, the touch screen display 126 may include proximity sensing capabilities and in such embodiments, direct contact between the input object and surface of the touch screen display 126 may not be required. Accordingly, where an input object is described to be in contact with the surface of the touch screen display 126, it will be appreciated that “contact” may include direct contact as well as sufficient proximity for the touch screen display 126 to sense the input object.

In some embodiments, a touch interaction may require additional criteria to be identified by the touch screen interface circuitry 128 as the trigger touch interaction described above. For example, a trigger touch interaction may comprise sliding the input object along the path from the point of origin outside of the active region to the point within the active region at a rate (e.g., an initial rate upon crossing into the active region) greater than a predefined threshold. This criteria may allow, for example, the touch screen interface circuitry 128 to differentiate between a trigger touch interaction (e.g., slide-in gesture) as described above and another touch interaction that may start close to an edge of an active region and continue inside the active region, such as a gesture for selecting a content object located close to the edge of the active region and dragging it inside the active region. The latter gesture may, for example, have an initial rate upon crossing into the active region of close to or equal to zero.

An additional or alternative criteria for a touch interaction to be identified by the touch screen interface circuitry 128 as a trigger touch interaction described above, may comprise the path of the input object from the point of origin to a point within the active region not traversing a content object for one or more of a predefined time period or a predefined distance following the input object crossing an edge of the active region. Such criteria may likewise help the touch screen interface circuitry 128 to differentiate between various touch interactions and to distinguish the trigger touch interaction described above from, for example, a touch interaction used for activating or dragging a content object that is close to an edge of the active region.

In some embodiments, the active region of the touch screen display 126 may comprise, for example, an entirety of the surface area of the touch screen display 126. Accordingly, in such embodiments, the input object may be slid along a path from a point of origin on or outside an edge of the touch screen display to a point within the touch screen display 126 so as to provide the predefined trigger touch interaction (e.g., a slide-in gesture). It will be appreciated that in such embodiments the point of origin of the touch interaction may lie outside of the detectable range of the touch screen display 126. Accordingly, the touch screen interface circuitry 128 may be configured to identify a trigger touch interaction in embodiments wherein the active region comprises the entirety of the touch screen display 126 in that the first detected point of the touch interaction is one or more pixels immediately adjacent to the edge of the touch screen display 126 (e.g., the point where the input object crosses over an edge of the touch screen display 126.)

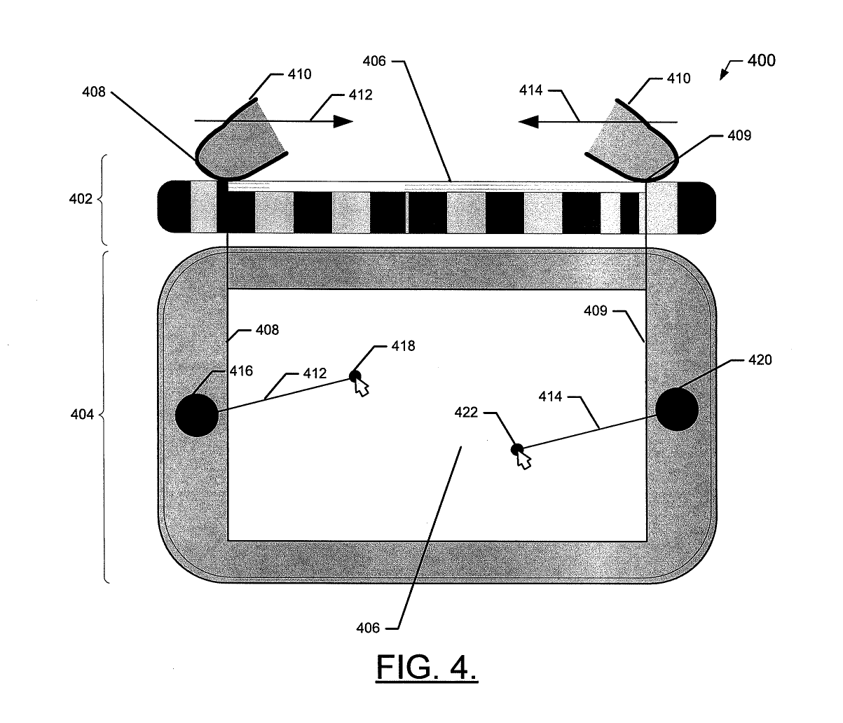

FIG. 4 illustrates a side profile 402 and front profile 408 of an example embodiment of a touch screen apparatus 400 in which an active region may comprise an entirety of a touch screen display. In this regard, the touch screen apparatus 400 comprises a touch screen display 406 that has a surface that is substantially on the same plane as a surface of a housing of the touch screen apparatus 400. Accordingly, there is not a significant raise or drop off at the edges 408 and 409 between the touch screen display 406 and the surrounding housing that lies outside the active region of the touch screen display 406. A user may therefore slide an input object 410 along a path 412 from a point of origin 416 on the housing of the touch screen apparatus 400 to a point 418 on the active region of the touch screen display 406, such that the path 412 traverses the edge 408. Similarly, a user may slide the input object 410 along a path 414 from a point of origin 420 on the housing of the touch screen apparatus 400 to a point 422 on the active region of the touch screen display 406, such that the path 414 traverses the edge 409.

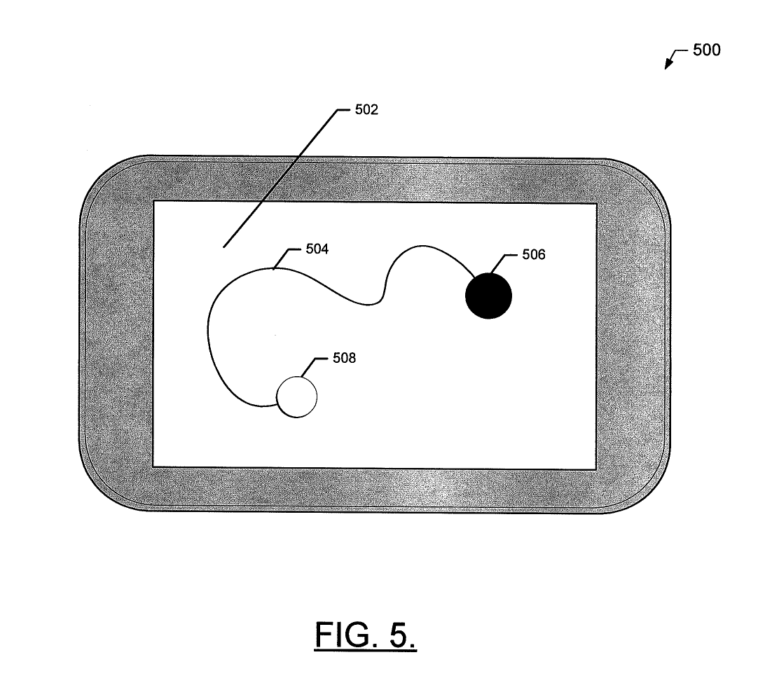

FIG. 5 illustrates a touch interaction having a point of origin within an active region comprising an entirety of a touch screen display 502 of a touch screen apparatus 500 according to an example embodiment of the invention. The touch screen apparatus 500 may comprise, for example, the touch screen apparatus 102. In this example, a user has provided a touch interaction comprising sliding an input object along a path 504 having a point of origin 506 within the active region of the touch screen display 502 to a point 508 that is also within the active region. Since the touch interaction does not comprise a sliding of an input object along a path from a point of origin outside of the active region, the touch screen interface circuitry 128 of some embodiments may be configured to determine that the touch interaction depicted in FIG. 5 does not comprise a trigger touch interaction.

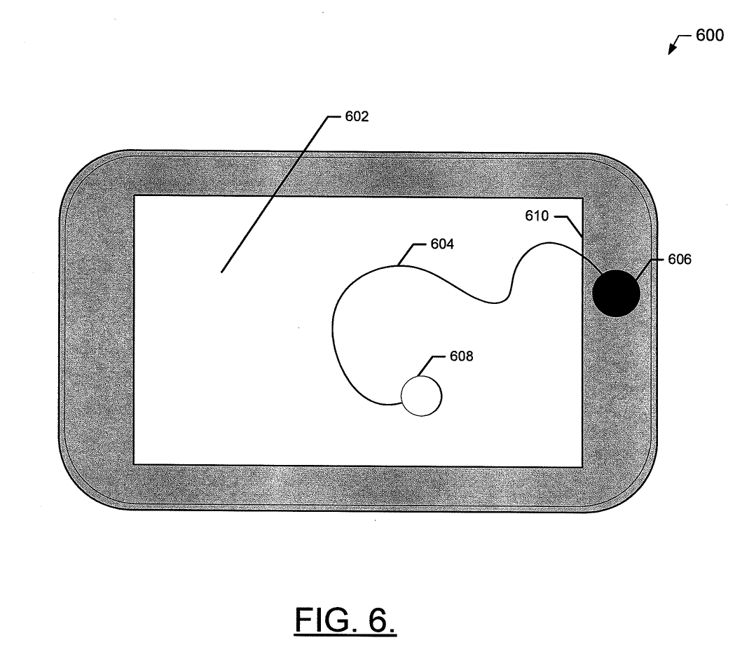

FIG. 6 illustrates a touch interaction having a point of origin outside of an active region of a touch screen display 602 of a touch screen apparatus 600 according to an example embodiment of the invention. The touch screen apparatus 600 may comprise, for example, the touch screen apparatus 102. In this example, a user has provided a touch interaction comprising sliding an input object along a path 604 having a point of origin 606 outside of the active region of the touch screen display 602 to a point 608 that is within the active region. Along the path 604, the input object crosses the edge 610 and at that point, contact may be first detected between the touch input and touch screen display such that it may be determined that a true point of origin of the path of the touch interaction is outside of the active region of the touch screen display 602. Accordingly, the touch screen interface circuitry 128 may be configured to identify the touch interaction depicted in FIG. 6 as comprising a trigger touch interaction.

Alternatively, in some embodiments, the active region of the touch screen display 126 may comprise, for example, a region of the touch screen display residing a predefined distance (e.g., a predefined number of pixels) from an edge of the touch screen display 126. In this regard, the active region may be at least partially defined by an exterior border located a predefined distance from an edge of the touch screen display 126. Thus, in such embodiments, the area of the touch screen display 126 residing between the edge of the touch screen display 126 and the exterior border of the active region lies outside of the active region of the touch display 126. In such embodiments, the input object may be slid along a path from a point of origin located between the exterior border of the active region and the edge of the touch screen display 126 to a point within the active region so as to provide the trigger touch interaction (e.g., a slide-in gesture).

In still further embodiments, the active region of the touch screen display 126 may comprise a region of the touch screen display in which a graphical user interface for an application is displayed. For example, if the touch screen apparatus 102 implements a windowed operating system, a window for an application may be displayed in a portion of the touch screen display 126. Accordingly, in such embodiments, the input object may be slid along a path from a point of origin outside of the region of the touch screen display 126 in which the graphical user interface for the application is displayed to a point within the region of the touch screen display 126 in which the graphical user interface for the application is displayed so as to provide the trigger touch interaction.

In an example embodiment, one or more of the trigger touch interactions described above (e.g., a slide-in gesture) is associated with a function for switching from a first mode of interaction with a graphical user interface to a second mode of interaction with a graphical user interface. For example, a first mode of interaction with a graphical user interface may comprise a DEFAULT or DIRECT mode, which enables a user to use non-trigger touch interactions to pan, activate/select a content object, and/or perform other functionality that might, for example, be performed with a left click button of a WIMP input device in non-touch screen apparatuses. A second mode of interaction may, for example, comprise a HOVER mode in which non-trigger touch interactions may be interpreted by the touch screen interface circuitry 128 as hover or mouse-over interactions.

Accordingly, in various embodiments, upon detection of a trigger touch interaction, the touch screen interface circuitry 128 may be configured to switch to a hover mode of interaction. Additionally or alternatively, upon detection of a trigger touch interaction, the touch screen interface circuitry 128 may be configured to switch from an activated mode of interaction (e.g. DEFAULT or HOVER) to an inactive mode of interaction (e.g., HOVER or DEFAULT). Thus in some embodiments, a user may provide a touch interaction comprising sliding an input object along a path from a point of origin outside of an active region of the touch screen display 126 to a point within the active region in order to switch between modes of interaction that define how touch interactions are interpreted by the touch screen interface circuitry 128.

The touch screen interface circuitry 128 may accordingly be configured to determine a function to execute in response to detecting a non-trigger touch interaction based at least in part upon an activated mode of interaction. For example, if HOVER mode is activated and the user performs a non-trigger touch interaction over an underlying content object comprising a menu item having a pop-up submenu configured for display on mouse-over, the touch screen interface circuitry 128 may be configured to cause the pop-up submenu to be displayed in response to the non-trigger touch interaction. However, if a DEFAULT mode is activated and the user performs a non-trigger touch interaction over the same underlying content object, which may be configured to link to a different content page when activated (e.g., when clicked on with a WIMP input device), the touch screen interface circuitry 128 may be configured to cause the linked content to be displayed in response to the non-trigger interaction.

In some embodiments, the touch screen interface circuitry 128 is configured to execute the function to switch between modes of interaction in response to detecting a trigger action regardless of whether contact between the input object and the touch screen display 126 has ceased subsequent to detection of a trigger touch action comprising sliding an input object along a path from a point of origin outside of an active region to a point within the active region. Alternatively, in some embodiments, the touch screen interface circuitry 128 may be configured to detect a cessation of contact between the input object and touch screen display 126 subsequent to detecting a trigger touch interaction (e.g., the first time the input object is lifted from the touch screen display 126 following completion of a path from a point of origin outside of an active region to a point within the active region). In such alternative embodiments, the touch screen interface circuitry 128 may be configured to switch between modes of interaction (e.g., to HOVER mode) only after detecting the cessation of contact.

In some embodiments, after the touch screen interface circuitry 128 has switched to a second mode of interaction (e.g., to a HOVER mode) in response to detection of a trigger touch interaction, the second mode of interaction remains activated until the touch screen interface circuitry 128 detects a second trigger touch interaction. This second trigger touch interaction may comprise, for example, a user again sliding an input object along a path from a point of origin outside of an active region of the touch screen display 126 to a point within the active region. Such embodiments may allow a user to make repetitive touch interactions that will be interpreted as, for example, mouse-over actions, without having to perform a trigger touch interaction before each touch interaction the user wishes to be interpreted as a mouse-over action.

In alternative embodiments, after the touch screen interface circuitry 128 has switched to a second mode of interaction (e.g., to a HOVER mode) in response to detection of a trigger touch interaction, the second mode of interaction may remain activated until the touch screen interface circuitry 128 detects a cessation of contact between the input object and the touch screen display 126 (e.g., at a point within the active region). In such alternative embodiments, it will be appreciated that the touch screen interface circuitry 128 may be configured to switch back to a default mode of interaction in response to the user releasing the input object from contact with the touch screen display 126. If the user then wishes to switch back to the second mode (e.g., hover mode), the used can then perform another trigger touch interaction comprising sliding the input object along a path from a point of origin outside of the active region to a point within the active region and maintain contact between the input object and touch screen display so long as the user wishes to remain in the second mode of interaction. Such alternative embodiments may aid the user in that the user may be able to more readily keep track of which mode of interaction is currently activated so that the user will know how a touch interaction will be interpreted.

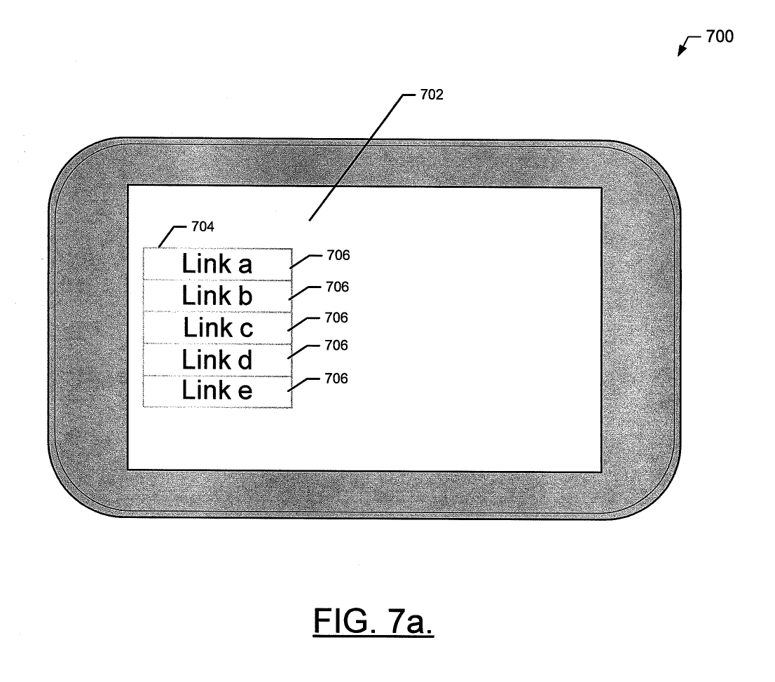

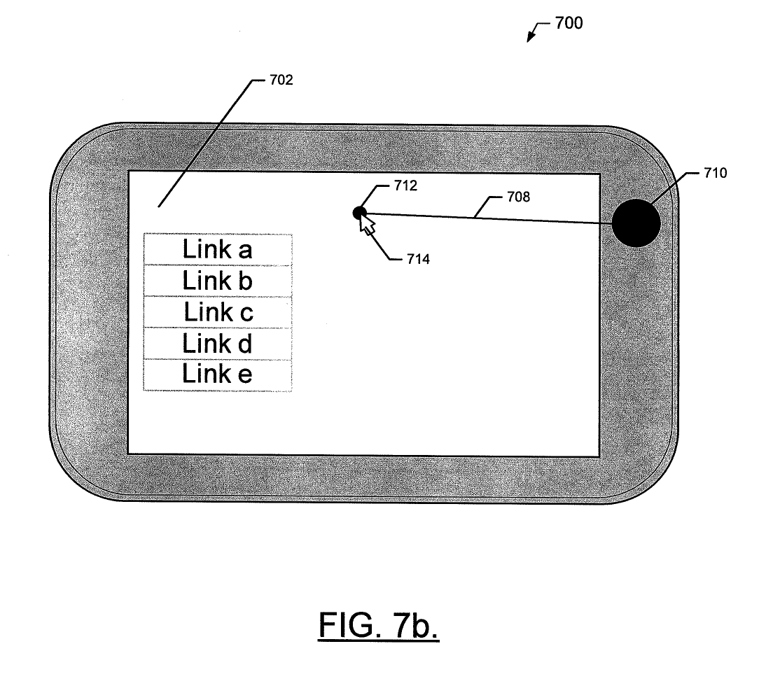

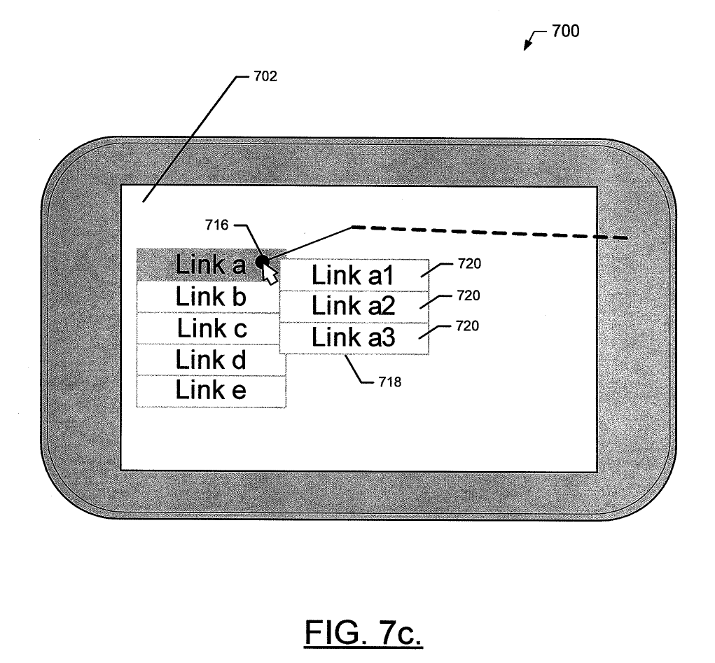

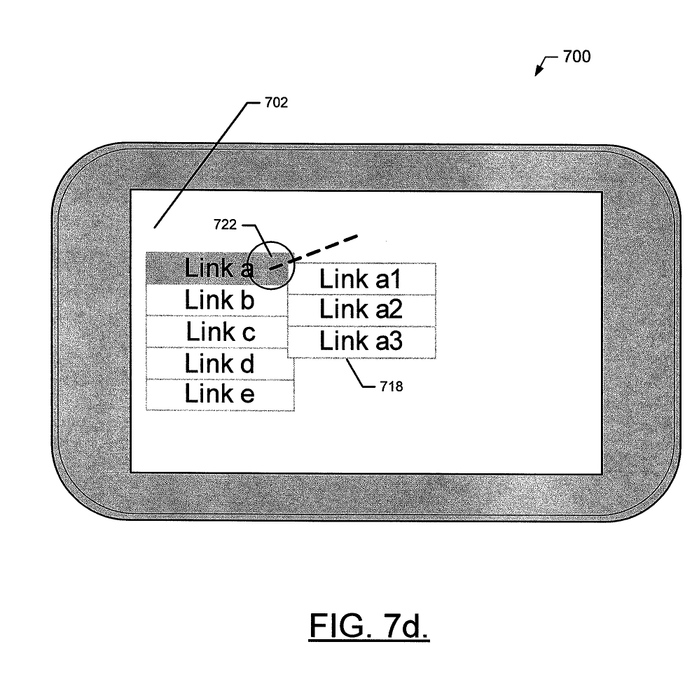

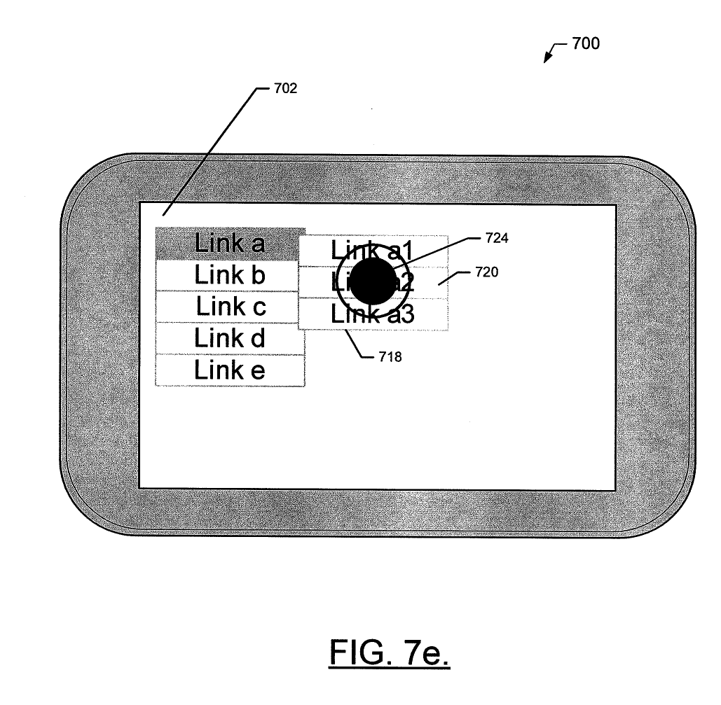

FIGS. 7a-7e illustrate a series of touch interactions with content that may be displayed by a touch screen display according to an example embodiment of the invention. In this regard, FIGS. 7a-7e illustrate content that may be displayed by a touch screen display 702 of a touch screen apparatus 700 and touch interactions therewith. The touch screen apparatus 700 may comprise, for example, the touch screen apparatus 102. Referring now to FIG. 7a, the touch screen display 702 may display a menu 704 comprising a list of options, or content objects, 706. The menu 704 may, for example, comprise a dynamic menu having mouse-over functionality, such as may be displayed on a web page.

Referring now to FIG. 7b, a user has provided a trigger touch interaction by sliding an input object along a path 708 from a point of origin 710 outside of an active region of the touch screen display 702 to a point 712 within the active region. The touch screen interface circuitry 128 may detect the trigger touch interaction and, in response thereto, switch to a HOVER mode of interaction with the graphical user interface displayed on the touch screen display 702. In one embodiment, a cursor 714 is located at a present cursor location as determined by a location at which the input object is contacting the touch screen display 702. In FIG. 7b, a cursor 714 is displayed at the point 712, as the input object is still in contact with the touch screen display 702 at point 712.

Referring now to FIG. 7c, the user may provide a further touch interaction comprising dragging the input object to the point 716, which is within the content object 706, labeled “Link a.” The touch screen interface circuitry 128 may detect the further touch interaction and determine based at least in part upon HOVER mode being activated and the touch interaction comprising an interaction at the point 716 overlying the content object 706, that a hover function of displaying the sub-menu 718 comprising a list of associated content objects 720 should be displayed. The touch screen interface circuitry 128 may then cause the sub-menu 718 to be displayed, as illustrated in FIG. 7c.

After the sub-menu 718 has been displayed, the user may provide an additional touch interaction to trigger the touch screen interface circuitry 128 to switch from HOVER mode to a DEFAULT mode of interaction so that the user may select and activate one of the content objects 720. Depending on the embodiment, such additional touch interaction may comprise, for example, breaking contact between the input object and the touch screen display 702 (e.g., as illustrated by the open circle 722 in FIG. 7b), performing another trigger touch interaction as illustrated in FIG. 7b, or other embodiment appropriate touch interaction for signaling to switch interaction mode back to DEFAULT. Regardless, once the user has switched back to DEFAULT mode, the sub-menu may remain displayed until the user provides a subsequent touch interaction.

Referring now to FIG. 7e, after the user has provided a touch interaction to switch the mode of interaction back to DEFAULT, the user may use an input object to tap or otherwise interact with the touch screen display at a point 724 overlying the content object 720 labeled “Link a2” so as to select and activate Link a2. The touch screen interface circuitry 128 may detect the touch interaction at point 724 and determine based at least in part upon DEFAULT mode being activated and the touch interaction comprising an interaction at the point 724 overlying the content object 720, that the content to which Link a2 points when activated should be displayed. Although not illustrated, the touch screen interface circuitry 128 may then cause the linked content to be displayed.

Although so far, discussion of a function associated with a trigger touch interaction has focused on switching between modes of interaction with a graphical user interface, it will be appreciated that other functions may be associated with a trigger touch interaction in addition to or in lieu of switching between modes of interaction. For example, a trigger touch interaction may be associated with a function comprising toggling between an input mode wherein a touch interaction is interpreted as a left-click and an input mode wherein a touch interaction is interpreted as a right-click (e.g., a left-click or right-click of a WIMP input device). Additionally or alternatively, a trigger touch interaction may be associated with one or more application-specific shortcuts or commands.

It will be appreciated that in embodiments wherein a trigger touch interaction is associated with multiple functions, the touch screen interface circuitry 128 may be configured to use context criteria to determine which of the functions associated with the trigger touch interaction should be executed and then execute the determined function. For example, the touch screen interface circuitry 128 may be configured to determine a function associated with a trigger touch interaction based at least in part upon a direction of the path of the trigger touch interaction. For example, referring to FIG. 4, a trigger touch interaction following the path 412, from left-to-right across the touch screen display 406 may be associated with a different function than the trigger touch interaction following the path 414 from right-to-left across the touch screen display. The trigger touch interaction following a left-to-right path may, for example, be associated with a function to switch to DEFAULT mode. The trigger touch interaction following a right-to-left path may, for example, be associated with a function to switch to HOVER mode. However, again functions other than interaction mode switches may be assigned to various path directions. For example, a trigger touch interaction following a left-to-right path may be associated with a function for displaying an inbox for a contact and a trigger touch interaction following a right-to-left path may be associated with a function for displaying bookmarks stored by a web browser. It will be appreciated that the touch screen interface circuitry 128 may be configured to determine other path directions, such as, for example, top-to-bottom, bottom-to-top, various diagonal path directions, and/or the like such that functions may be associated with respective path directions.

In another example, the touch screen interface circuitry 128 may be configured to determine a function associated with a trigger touch interaction based at least in part upon a region of an edge of the active region of the touch screen display 126 that the input object traverses on the path from the point of origin to a point within the active region. For example, a first function may be assigned to a trigger touch interaction traversing a top edge, a second function may be assigned to a trigger touch interaction traversing a right side edge, a third function may be assigned to a trigger touch interaction traversing a bottom edge, and a fourth function may be assigned to a trigger touch interaction traversing a left side edge. It will be appreciated that further edge divisions may be used. For example, edges may be divided bilaterally, such that unique functions may be assigned, for example, to a left-top edge, right-top edge, top-right edge, bottom-right edge, etc.

In another example, the touch screen interface circuitry 128 may be configured to determine a function associated with a trigger touch interaction based at least in part upon a currently executed application. For example, when a phone book is being executed, a trigger touch interaction may be associated with displaying a call history for a contact. If a browser application is being executed, a trigger touch interaction may be associated with displaying bookmarks stored by the web browser. In windowed operating systems wherein multiple applications may be executed concurrently, the touch screen interface circuitry 128 may be configured to determine the function associated with a trigger touch interaction based on which executed application is displayed in the top-most window. Alternatively, in windowed operating systems, the touch screen interface circuitry 128 may be configured to determine the application associated with a graphical user interface window underlying a point at which the trigger touch interaction terminates and then determine the function associated both with the determined application and the detected trigger touch interaction.

In another example, the touch screen interface circuitry 128 may be configured to determine a function associated with a trigger touch interaction based at least in part upon an object underlying a point at which the trigger touch interaction terminates. For example, if a phonebook application is being executed and a list of contacts is displayed and the user performs a trigger touch interaction that terminates at a point overlying the contact object “John Smith,” the touch screen interface circuitry 128 may be configured to determine based on the termination point overlying the contact object “John Smith” to display the call history for John Smith.

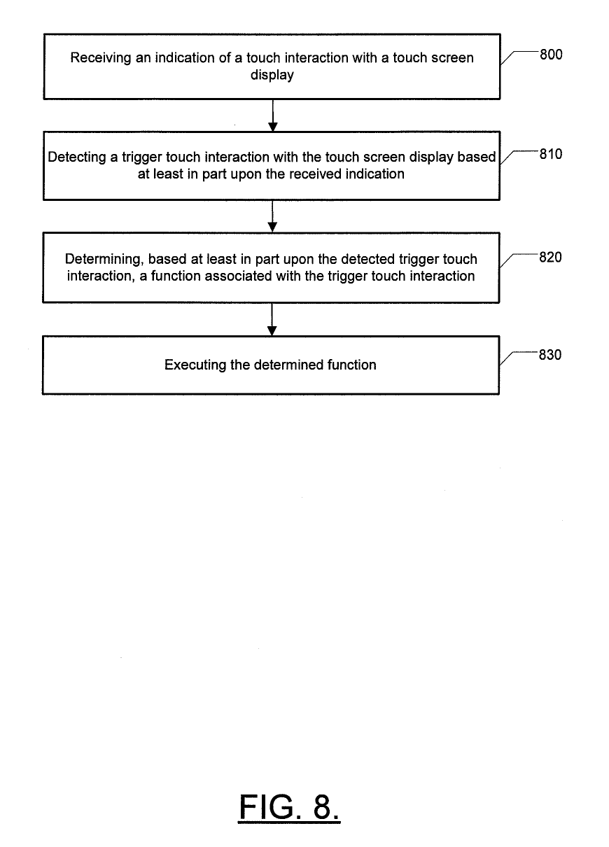

FIG. 8 illustrates a flowchart according to an example method for facilitating interaction with touch screen apparatuses according to an example embodiment of the invention. The operations illustrated in and described with respect to FIG. 8 may, for example, be performed by or under the control of the touch screen interface circuitry 128. Operation 800 may comprise receiving an indication of a touch interaction with a touch screen display (e.g., the touch screen display 126). This indication may be provided, for example, by the touch screen display 126 and/or processor 120. Operation 810 may comprise detecting a trigger touch interaction with the touch screen display based at least in part upon the received indication. In this regard, operation 810 may comprise identifying a touch interaction detected based on the received indication as a trigger touch interaction. The trigger touch interaction may comprise, for example, sliding an input object along a path from a point of origin outside of an active region of the touch screen display to a point within the active region. Operation 820 may comprise determining, based at least in part upon the detected trigger touch interaction, a function associated with the trigger touch interaction. Operation 830 may comprise executing the determined function.

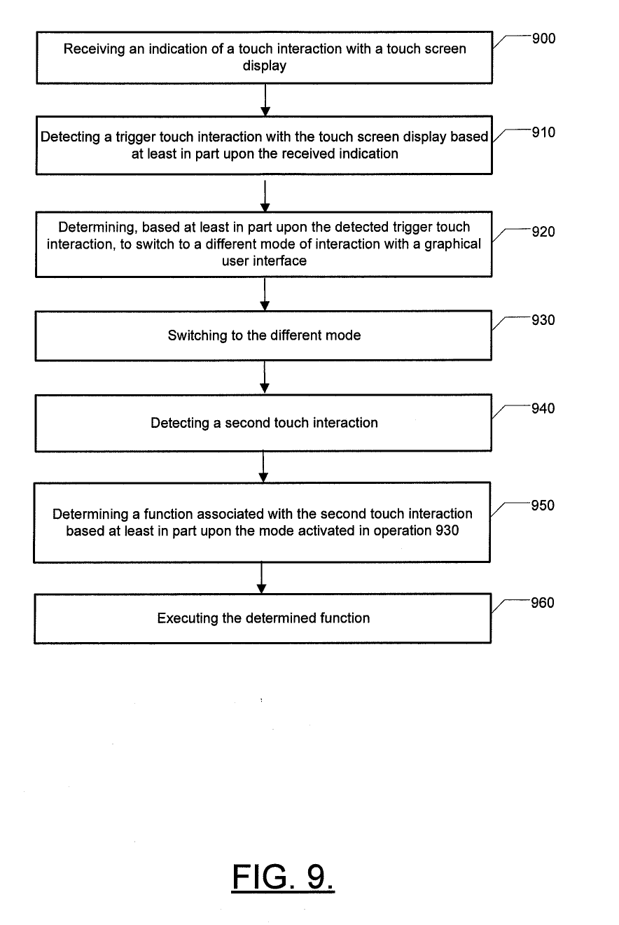

FIG. 9 illustrates a flowchart according to another example method for facilitating interaction with touch screen apparatuses according to an example embodiment of the invention. The operations illustrated in and described with respect to FIG. 9 may, for example, be performed by or under the control of the touch screen interface circuitry 128. Operation 900 may comprise receiving an indication of a touch interaction with a touch screen display (e.g., the touch screen display 126). This indication may be provided, for example, by the touch screen display 126 and/or processor 120. Operation 910 may comprise detecting a trigger touch interaction with the touch screen display based at least in part upon the received indication. In this regard, operation 910 may comprise identifying a touch interaction detected based on the received indication as a trigger touch interaction. The trigger touch interaction may comprise, for example, sliding an input object along a path from a point of origin outside of an active region of the touch screen display to a point within he active region. Operation 920 may comprise determining, based at least in part upon the detected trigger touch interaction, to switch to a different mode of interaction with a graphical user interface (e.g., to switch from a DEFAULT mode to a HOVER mode, or vice versa). Operation 930 may comprise switching to the different mode. Operation 940 may comprise detecting a second touch interaction. Operation 950 may comprise determining a function associated with the second touch interaction based at least in part upon the mode activated in operation 930. Operation 960 may comprise executing the determined function.

FIGS. 8-9 are flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a touch screen apparatus, or other computing device (e.g., the touch screen apparatus 102, and/or the like) and executed by a processor (e.g., the processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. Embodiments of the invention provide touch screen apparatuses configured to detect a trigger touch interaction associated with a function and to execute the determined function. In some embodiments, a designated trigger touch interaction is associated with a function to change a mode of interaction with a graphical user interface displayed by a touch screen display. Such a mode of interaction controls the effect of touch interactions with the touch screen display. According to some such embodiments, a user may provide the designated trigger touch interaction as a command to the touch screen apparatus and, in response, the touch screen apparatus is configured to switch from a default mode of interaction to a hover mode of interaction, which according to some embodiments enables a user to interact with displayed content objects via touch interaction to command hover events (“mouse-over events”). Touch screen devices according to some embodiments of the invention are configured, in response to a second designated trigger touch interaction, to switch from hover mode to the default mode of interaction, which according to some embodiments enables a user to command panning interactions (e.g., moving a document inside a browser or application window), direct manipulation/interaction with an application (e.g., selecting text, activating an application option, and/or the like), such as may be performed using a left-click with a traditional WIMP device (“mouse-click events”).

Accordingly, embodiments of the invention provide enhanced support for Internet or hypermedia applications (e.g., web browsers), office applications (e.g., word processing applications, spreadsheet applications, and/or the like), and/or the like via a touch screen display by allowing a user to switch modes of interaction without degrading the capability to support more frequently needed functionalities, such as moving a portion of a document displayed by the touch screen display via panning, which may be performed in a default mode of interaction. Embodiments of the invention further provide for one hand usage of touch screen apparatuses without requiring a user to use a second hand to enter key strokes or other input to change a mode of interaction controlling the effect of touch interactions with the touch screen display. Embodiments of the invention additionally do not require special hardware keys/buttons or graphical user interface keys/buttons for switching between modes of interaction and provide the ability for a user to alternate between modes of interaction at any time with a designated trigger touch interaction.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a touch interaction with a touch screen display;
identifying, by a processor, the touch interaction as comprising a trigger touch interaction, the trigger touch interaction comprising sliding an input object along a path from a first point at least partially coinciding with a non-display portion proximate to at least a portion of the touch screen display to a point within an active region of the touch screen display;
determining, based at least in part upon the trigger touch interaction, a function associated with the trigger touch interaction; and
executing the determined function.

2. The method of claim 1, wherein the active region of the touch screen display is at least partially defined by a border positioned a predefined distance from an edge of the touch screen display.

3. The method of claim 1, wherein the first point at least partially coincides with a portion of the touch screen display.

4. The method of claim 1, wherein the first point is coincident with any portion of the non-display portion.

5. The method of claim 1, wherein a surface of the non-display portion and a surface of the touch screen display are disposed on a common plane.

6. The method of claim 1, further comprising:
receiving an indication of a second touch interaction with a touch screen display;
determining that the second touch interaction is different than a trigger touch interaction;
responsive to the determination that the second touch interaction is different than a touch interaction, determining a function associated with the second touch interaction; and
executing the function determined to be associated with the second touch interaction.

7. An apparatus comprising at least one processor and at least one memory storing computer program code, wherein the at least one memory and stored computer program code are configured to, with the at least one processor, cause the apparatus to at least:
receive an indication of a touch interaction with a touch screen display;
identify the touch interaction as comprising a trigger touch interaction, the trigger touch interaction comprising sliding an input object along a path from a first point at least partially coinciding with a non-display portion proximate to at least a portion of the touch screen display to a point within an active region of the touch screen display;
determine, based at least in part upon the trigger touch interaction, a function associated with the trigger touch interaction; and
execute the determined function.

8. The apparatus of claim 7, wherein the active region of the touch screen display is at least partially defined by a border positioned a predefined distance from an edge of the touch screen display.

9. The apparatus of claim 7, wherein the first point at least partially coincides with a portion of the touch screen display.

10. The apparatus of claim 7, wherein the first point is coincident with any portion of the non-display portion.

11. The apparatus of claim 7, wherein a surface of the non-display portion and a surface of the touch screen display are disposed on a common plane.

12. The apparatus of claim 7, wherein the at least one memory and stored computer program code are configured to, with the at least one processor, further cause the apparatus to:
receive an indication of a second touch interaction with a touch screen display;
determine that the second touch interaction is different than a trigger touch interaction;
responsive to the determination that the second touch interaction is different than a touch interaction, determine a function associated with the second touch interaction; and execute the function determined to be associated with the second touch interaction.

13. The apparatus of claim 7, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of the touch screen display; and
cause at least a portion of a user interface of the mobile phone to be displayed on the touch screen display to facilitate user control of at least some functions of the mobile phone.

14. A computer program product comprising at least one non-transitory computer-readable storage medium having computer-readable program instructions stored therein, the computer-readable program instructions comprising:
program instructions configured to receive an indication of a touch interaction with a touch screen display;
program instructions configured to identify the touch interaction as comprising a trigger touch interaction, the trigger touch interaction comprising sliding an input object along a path from a first point at least partially coinciding with a non-display portion proximate to at least a portion of the touch screen display to a point within an active region of the touch screen display;
program instructions configured to determine, based at least in part upon the trigger touch interaction, a function associated with the trigger touch interaction; and
program instructions configured to execute the determined function.

15. The computer program product of claim 14, wherein the active region of the touch screen display is at least partially defined by a border positioned a predefined distance from an edge of the touch screen display.

16. The computer program product of claim 14, wherein the first point at least partially coincides with a portion of the touch screen display.

17. The computer program product of claim 14, wherein the first point is coincident with any portion of the non-display portion.

18. The computer program product of claim 14, wherein a surface of the non-display portion and a surface of the touch screen display are disposed on a common plane.

19. The computer program product of claim 14, the computer-readable program instructions further comprising:
program instructions configured to receive an indication of a second touch interaction with a touch screen display;
program instructions configured to determine that the second touch interaction is different than a trigger touch interaction;
program instructions configured responsive to the determination that the second touch interaction is different than a touch interaction, to determine a function associated with the second touch interaction; and
program instructions configured to execute the function determined to be associated with the second touch interaction.
